(19) United States
(12) Patent Application Publication
(10) Pub. No.: US 2015/0235209 A1
(43) Pub. Date: Aug. 20, 2015

(54) LOCATION BASED TRANSACTION LIABILITY ALLOCATION

(71) Applicant: Bank of America Corporation, Charlotte, NC (US)

(72) Inventors: Matthew D. Murphy, Charlotte, NC (US); Jeffrey N. Healy, Matthews, NC (US); Steven M. Twombly, Saco, ME (US); Rosemary C. Stack, Wilmington, DE (US); Mark R. Wilson, Middletown, DE (US)

(21) Appl. No.: 14/184,536

(22) Filed: Feb. 19, 2014

(51) Int. Cl. G06Q 20/38; G06Q 20/40

(52) U.S. Cl. CPC G06Q 20/382; G06Q 20/409; G06Q 2220/00

(57) ABSTRACT

Apparatus and methods for allocating transaction liability are provided. Transaction liability may include a risk that the transaction may incur a post-authorization charge, such as a fraud investigation and/or a chargeback. The transaction liability may be allocated among one or more transaction participants. Transaction liability may be allocated based on a stock-keeping-unit of an item purchased by customer that initiates the transaction. Transaction liability may be allocated based on an amount of the transaction. Transaction liability may be allocated based on a merchant category code identifier assigned to a merchant. Transaction liability may be allocated based on a location of a merchant. A default allocation of transaction liability may be re-allocated among transaction participants based on level of verification performed by a transaction participant at a point-of-sale.

### FIELD OF TECHNOLOGY

Aspects of the disclosure relate to providing apparatus and methods for allocating a liability associated with a transaction between two or more transaction participants.

### BACKGROUND

A customer may purchase goods or services (“the product”) from a merchant by presenting a payment instrument at a point-of-sale. The purchase may be conducted through any suitable channel of commerce. The payment instrument may allow the customer to draw on a line-of-credit. The line-of-credit may be extended to the customer by an issuing bank (the “issuer”) associated with the payment instrument. The payment instrument may allow the customer to submit a request to debit of an account of the customer held at a financial institution. The account of the customer may be maintained by the issuer associated with the payment instrument.

The merchant may present the transaction to an acquiring bank (the “acquirer”). The acquirer may request authorization for the transaction from the issuer. The issuer may be provided an opportunity to authorize the transaction before extending credit to the customer or before accepting the request to debit the account of the customer. Typically, by providing authorization for the transaction, the issuer accepts a risk associated with the transaction. The risk may include a responsibility to respond to allegations of fraud, chargebacks, or other events that arise after an authorization has been provided. An issuer may decline to accept a transaction risk by denying the transaction in response to receiving an authorization request.

The acquirer may request authorization from the issuer by submitting the transaction to a transaction processing network. The transaction may be embodied in a transaction record that includes one or more attributes of the transaction. The transaction processing network may link the acquirer, the issuer and other transaction participants. The transaction processing network may receive an authorization from the issuer and transmit the authorization to the acquirer. In response to receiving the authorization from the issuer, the merchant may release the product to the customer.

In response to receiving an authorization from the issuer (i.e., via the transaction processing network), the acquirer pays the merchant for (and thus “acquires”) the transaction. The transaction processing network may collect transaction processing network fees from the issuer and the acquirer in connection with a transaction settlement process. The transaction processing network in communication with the issuer and the acquirer may settle the transaction between the issuer and the acquirer.

Settling the transaction may include the transaction network receiving a plurality of transactions from the acquirer. Each transaction may be embodied in a transaction record. A transaction record may include one or more attributes of the transaction. For example, each of the plurality of transaction records may comprise a purchase price amount authorized by the issuer.

A transaction settlement process may include a transfer of funds between two or more transaction participants. The transfer may be a “book transfer,” an inter-bank transfer or any suitable transfer between the transaction participants. A settlement network may transfer the funds between transaction participants. Illustrative settlement networks may include the Federal Reserve Wire Network (“Fedwire”) and other suitable settlement networks that are well known to those of ordinary skill in the art. The settlement network may include any suitable network linking one or more accounts of transaction participants.

A transaction participant may impose a transaction cost upon another transaction participant for participating in the transaction. The transaction cost may be referred to as “interchange.” Interchange may be a fixed fee for the transaction or a percentage of the transaction. Interchange may be a combination of a fixed fee and a percentage of the transaction.

Interchange typically flows from the acquirer, through the transaction processing network, to the issuer. For example, the issuer may transfer to the acquirer an amount net interchange. The issuer typically levies interchange to cover costs of acquiring credit/debit customers, servicing credit/debit accounts, providing incentives to retain customers, mitigating fraud, covering customer credit risk, group compensation, producing payment instruments and other expenses.

The acquirer may deduct a merchant discount from the amount that the acquirer pays the merchant in exchange for the product. The merchant discount may cover the acquirer's transaction processing network fee, interchange, and other expenses. The merchant discount may include a profit for the acquirer.

FIG. 1 shows typical transaction settlement flow 100. Flow 100 involves transaction participants such as the merchant, the customer, and transaction participants identified below. At step 1, the merchant provides $100 in product to the customer. To obtain the $100 in product, the customer may present a payment instrument. Presenting the payment instrument to the merchant may initiate a credit, debit or other electronic transaction. Presenting the payment instrument to the merchant may transfer information associated with the payment instrument to the merchant.

At step 2, the merchant submits a request for authorization to a transaction authorization and clearance provider. The transaction authorization and clearance provider may be an issuer associated with the payment instrument presented by the customer. The authorization request may be communicated to the transaction authorization and clearance provider by the acquirer.

The transaction authorization and clearance provider may provide transaction authorization and clearance information to the merchant/acquirer. The transaction authorization information may be transferred from the issuer to the merchant via a transaction processing network. The transaction authorization and clearance information may include authorization for the transaction to proceed.

At step 3, the issuer transmits to the customer a statement showing the purchase price of $100.00 due. The issuer collects the purchase price amount, along with interest and fees if appropriate, from the customer. At step 4, the issuer routes the purchase price amount of $100.00 through the transaction processing network to the acquirer. At step 5, the acquirer partially reimburses the merchant for the purchase price amount. In the example shown in FIG. 1, the partial reimbursement is $98.00. The difference between the reimbursement amount $98.00 and the purchase price amount $100.00 is a two dollar $2.00 merchant discount.

At step 6, the acquirer pays a transaction cost $1.50, via the transaction processing network, to the issuer. At step 7, both the acquirer and the issuer pay a transaction cost ($0.07 for acquirer and $0.05 for the issuer) to the transaction processing network.

TABLE 1
Net positions, by participant, based on settlement
flow 100 (shown in FIG. 1).

| Participant | Net ($) |
|---|---|
| Issuer | 1.45 |
| Acquirer | 0.43 |
| Transaction processing network | 0.12 |
| Merchant | −2.00 |
| Customer | 0 |

In settlement flow 100 (shown in FIG. 1), the transaction cost is based on an exemplary merchant discount rate of 2%. The $1.50 interchange is based on an exemplary interchange rate of 1.5%. The sum of the transaction processing network fees ($0.07 and $0.05) is based on a total exemplary transaction processing network fee rate of 0.12%.

Transaction processing networks and transaction processing network services are offered under trademarks known to those of ordinary skill in the art. Transaction processing networks and transaction processing network services offered under trademarks known to those of ordinary skill in the art such as VISA, MASTERCARD, NYCE and PULSE. Transaction processing networks may set interchange rates. Issuers may set interchange rates. Interchange rates may vary for each transaction processing network. Interchange rates may vary based on merchant type and size, transaction processing method, transaction volume and other factors.

In a typical settlement flow, such as FIG. 1, after step 2, when the issuer provides authorization for the transaction, the issuer bears responsibility for any charges or allegations of transaction fraud that may arise after authorization has been provided. For example, the customer may allege that, at step 1 the payment instrument information was fraudulently provided to the merchant. As a result of the allegation, the customer may refuse to pay one or more of the settlement, interest or fees depicted in step 3 of FIG. 1. Typically, the issuer bears a responsibility of investigating such an allegation of fraud. A cost of investigating an allegation of transaction fraud may be $15-$20 per transaction.

The costs associated with transaction fraud may include evaluating merits of a claim of transaction fraud, identifying a source of a fraud, reimbursing the customer, waiving one or more fees charged to the customer or other suitable costs. At least a portion of the interchange may be utilized by the issuer to cover the cost of transaction fraud.

Interchange rates may be regulated. For example, a governmental agency such as the U.S. Treasury Department may issue regulations setting a maximum amount for an interchange fee. Interchange rates may be regulated for credit, debit or other electronic transactions. Regulation of interchange may limit a portion of interchange available for responding to transaction fraud.

It would be desirable, therefore, to provide apparatus and methods for allocating transaction liability among transaction participants.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows a prior art scenario;

FIG. 2 shows a prior art information flow;

FIG. 3 shows an illustrative arrangement in accordance with the principles of the invention;

FIG. 4A shows an illustrative scenario in accordance with the principles of the invention;

FIG. 4B shows an illustrative scenario in accordance with the principles of the invention;

FIG. 5 shows an illustrative scenario in accordance with the principles of the invention;

FIG. 6 shows an illustrative arrangement of apparatus in accordance with the principles of the invention;

FIG. 7 shows an illustrative arrangement of apparatus in accordance with the principles of the invention

FIG. 8 shows an illustrative apparatus in accordance with the principles of the invention;

FIG. 9 shows an illustrative apparatus in accordance with the principles of the invention; and

FIG. 10 shows illustrative information in accordance with the principles of the invention.

### DETAILED DESCRIPTION OF THE INVENTION

Apparatus and methods for allocating a liability associated with a transaction are provided. A risk of incurring a transaction liability may be allocated among one or more transaction participants. The liability may include a cost associated with transaction fraud. Exemplary costs associated with transaction fraud are listed below in table 2.

TABLE 2
Illustrative Costs of Transaction Fraud

Investigation allegations of fraud
Damage to corporate goodwill
Monetary compensation paid to settle fraud
claims
Delay in receiving payments due
Payments to Acquirer/Merchant
Payments to Transaction Processing Network
Invoicing costs for transaction services

The liability may include other suitable costs. The liability may include costs associated with a transaction that may be incurred after an issuer has authorized the transaction. Illustrative post-authorization costs may include chargeback costs.

A chargeback provides an issuer with a method of returning a transaction disputed by a customer. A chargeback situation may arise for reasons that include: a merchant failed to obtain an authorization, a transaction record that is altered, a transaction record that does not include a signature of the customer or a valid personal-identification-number (“PIN”), a merchant failed to obtain an imprint (electronic or manual) of a payment instrument presented by the customer and/or a merchant accepted an expired payment instrument.

When a chargeback right applies, the issuer sends the transaction back to the acquirer and “charges back” the dollar amount of the disputed purchase. The acquirer may then deduct the amount of the chargeback from the merchant's account. If there are no funds in the merchant's account to cover the chargeback amount, the acquirer may be obligated to cover a loss associated with the chargeback.

A merchant may re-present the chargeback to its acquirer. If the merchant cannot remedy the chargeback (i.e., by showing that an imprint of the payment instrument has been obtained), the merchant bears a loss associated with the chargeback.

A transaction may involve an acceptance of a payment instrument by a merchant. The transaction may involve a credit, debit, prepaid, automated clearing house, or any suitable payment method involving the transfer of funds from one transaction participant to another.

The transaction may involve an acceptance of a payment instrument by a merchant. The transaction may be initiated by a customer presenting a payment instrument to make a purchase. The payment instrument may be a credit card, debit card, prepaid card, stored value card, gift card, ATM card, affinity-branded card, check card, corporate card, rewards card, charge card, embossed card, smart card and/or or any suitable payment instrument available on the market.

The transaction may be a pending transaction. For example, a transaction may be pending prior to receiving authorization from the issuer. The transaction may be pending during a time between receiving the authorization and settlement. The transaction may be pending during a time prior to collection, by the issuer, of the purchase amount from the customer.

The transaction may be an executed transaction. Executing the transaction may include a first transaction participant passing the transaction along to a second transaction participant. An executed transaction may include a transaction that has been authorized and settled.

The liability may be allocated among one or more transaction participants. Table 3 shows illustrative transaction participant types.

TABLE 3
Illustrative Transaction Participant Types

Merchant
Customer
Authorization service provider
Clearance service provider
Settlement service provider
Issuer
Network
Acquirer
Transaction broker

More than one participant of a given type may be available to participate in the transaction. Different participants of the same type may have advantages and/or disadvantages relative to the other participants of that type. For example, one issuer may be a member of a lending consortium while another is not a member, one transaction processing network may require payment of a relatively small interchange fee while another network may require payment of a relatively large interchange fee, and the like.

The payment instrument used to initiate the transaction may include a credit card, debit card and/or other forms of payment instruments. Such other forms of payment instruments may include: cash, a check, an instrument or device that includes a contactless chip, such as an ISO14443-compliant contactless chip, a smart phone, a tablet computer, a transponder or any other suitable electronic purchasing devices. Payment instruments may store data in a magnetic strip, a bar code, a silicon chip, non-volatile computer readable media or any other suitable data storage device or format.

The payment instrument may be presented to the merchant by the customer as payment for the product. The merchant may provide a point-of-sale (“POS”) terminal that is configured to receive data from, provide data to, or exchange data with the payment instrument. Illustrative payment instrument informational items that may be communicated to a POS terminal are shown below in table 4.

TABLE 4
Illustrative Payment Instrument Informational Items

Issuer
Transaction network
Customer name
Expiration date
Card security code (“CSC”)
Card verification data (“CVD”)
Card verification value (“CVV,” “CVV2,” “iCVV” or “Dynamic CVV”)
Card verification value code (“CVVC”)
Card verification code (“CVC”or “CVC2”)
Verification code (“V-code”)
Card code verification (“CCV”)
Signature panel code (“SPC”)
Customer identification number (“CID”)
Card account number
Brand
Card present transaction
Card not present transaction
Data storage (i.e., magnetic strip, smartphone, smart card ect . . . )
Affinity

As transaction may be associated with one or more transaction attributes. An allocation of transaction liability may be based on the one or more of the transaction attributes. Transaction attributes may be stored in a transaction record.

A transaction record may be generated based on transaction attributes received and/or available at a time of the transaction. Each transaction record may include one or more fields. Each field may include an attribute associated with the transaction. A transaction record may include one or more fields storing information associated with an attribute. Table 5 shows illustrative transaction attributes and illustrative information associated with each attribute.

TABLE 5

| Illustrative Transaction | Illustrative Associated |
|---|---|
| Attributes | Information |
| Geographic | Longitude/latitude |
| | GPS coordinates |
| | Map coordinates |
| | Elevation |
| | Depth |
| | Distance from a point |
| | Address |
| | Zip code |
| | Area code |
| | County |
| | State |
| | Country |
| | IP address |
| | Signal triangulation |
| Temporal | Seconds |
| | Minutes |
| | Hours |
| | Day |
| | Week |
| | Month |
| | Year |
| | Duration |
| Synoptic | Weather at time of |
| | transaction |
| | Stock market performance at |
| | time of transaction |
| | Political party in power at |
| | time of transaction |
| | Transaction participant risk |
| Transaction | Dollars |
| | Available credit |
| | Currency |
| | Foreign exchange rate |
| | Card present |
| | Card not present |
| Number of items purchased | Number |
| | Number of distinct stock |
| | keeping units (“SKU”) |
| | Cost/Value of item |
| Merchant category code | Numerical identifier |
| | Taxation status |
| | Associated acquirer |
| Payment instrument | Type (i.e., credit, debit, |
| | rewards ect . . . ) |
| | Data storage (i.e., magnetic |
| | strip, smartphone, smart card |
| | ect . . . ) |
| | Brand |
| | Transaction Network |
| | Issuer |
| | Acquirer |
| | Affinity |
| Loyalty program | Rewards/point balance |
| | Membership level |
| | Duration of membership |
| | Frequency of use |
| Access Channel | Point-of-sale |
| | Automated teller machine |
| | Online portal |
| | Self-service kiosk |
| | Mobile device |
| | In person |

A transaction attribute may be a synoptic attribute. The synoptic attribute may be derived by grouping individual transaction records that share one or more attributes. Transaction records may be grouped based on date, merchant category code (“MCC”), number of items purchased or a credit card identifier.

### Item/Amount Based Liability Allocation

Apparatus may include and methods may involve, a computer that allocates fraud liability associated with a debit card transaction. The fraud liability may be allocated among a plurality of transaction participants. The fraud liability may include a risk of incurring the fraud liability. The computer may include a non-transitory computer readable medium having computer readable program code (“code”) embodied therein. The computer may include a processor configured to execute the code.

The code, when executed by the processor, may configure the computer to perform one or more tasks. The code may instruct the computer to perform the one or more tasks.

The code may receive a stock-keeping-unit (“SKU”). The SKU may identify an item purchased by a customer. The code may receive the SKU from a POS device or system operated by a merchant.

The code may configure the computer to determine whether the SKU is associated with a fraud flag. A SKU may be associated with a fraud flag when a threshold number of transactions involving a purchase of the SKU are associated with a threshold post-authorization cost. For example, a SKU may correspond to a “new release” item or an otherwise desirable item. As a result of increased demand for the desirable item, the desirable item may be associated with increased levels of transaction fraud by imposter attempting to obtain the desirable item using another's payment instrument information.

The code may configure the computer to identify a payment instrument presented by the customer to pay for the item. The payment instrument may be identified as a debit card. A debit card transaction may be riskier transactions than a credit card transaction as a result of interchange regulation.

In response to determining that a SKU is associated with a fraud flag and identifying the payment instrument as a debit card, the code may configure the computer to allocate fraud liability associated with the debit card transaction. The code may allocate the fraud liability such that an issuer of the debit card bears less than 100% of any potential fraud liability.

The fraud liability may include a cost to investigate a claim submitted to an issuer of the debit card alleging that a purchase is fraudulent. The fraud liability may include a risk that a debit card transaction is fraudulent. The fraud liability may include a risk the debit card transaction is charged-back to an issuer of the debit card.

Allocating or sharing a portion of the liability associated with a transaction among two or more transaction participants may allow the transaction participants to share, with each other, a risk of incurring a post-authorization cost. Allocating the risk preferably provides an incentive to a transaction participant to take additional steps to mitigate the risk.

The computer may include code that, when executed by the processor, allocates at least a portion of the fraud liability associated with a debit card transaction to the merchant. The computer may include code that, when executed by the processor, allocates at least a portion of the fraud liability associated with the debit card transaction to an acquirer bank that processes the debit transaction on behalf of the merchant.

The computer may include code that when executed by the processor allocates a first portion of the fraud liability to the merchant and allocates a second portion of the fraud liability to the acquirer bank. The computer may include code that, when executed by the processor, allocates a first portion of the fraud liability to the merchant and allocates a second portion of the fraud liability to an issuer associated with the debit card.

The computer may include code that, when executed by the processor, allocates a first portion of the fraud liability to the merchant, allocates a second portion of the fraud liability to an issuer associated with the debit card and allocates a third portion of the fraud liability to a transaction network associated with the debit card. In such embodiments, a post-authorization cost may be shared by the merchant, issuer and transaction processing network. The post-authorization cost may be shared by the merchant, issuer and transaction processing network in any suitable proportion.

In some embodiments, a portion of the fraud risk may be shared with the customer. Sharing a portion of the risk with the customer may incentivize the customer to be vigilant in protecting payment instrument information in possession of the customer.

The computer may include code that when executed by the processor transmits the allocation of the fraud liability. The allocation may be transmitted to a transaction participant. The allocation may be transmitted to the transaction participant before a transaction is authorized. For example, the allocation may be transmitted to the merchant before the issuer authorizes the transaction.

The computer may include code that when executed by the processor receives, from the transaction participant, a proposed change to the allocation of the fraud liability. For example, a merchant, in response to receiving an allocation of transaction risk, may wish to reduce its exposure to the risk. The merchant may wish that an issuer or other transaction participant assume a greater portion of the transaction risk.

The computer may include code that when executed by the processor rejects a proposed change to the allocation of fraud liability. For example, for each of a plurality of transactions, a merchant may reject an initial risk allocation proposed by an issuer. The issuer may accept a re-allocation proposed by the merchant. The issuer may accept a re-allocation proposed by the merchant if the re-allocation does not subject the issuer to risk above a threshold amount for transactions that originate from the merchant.

A proposed change or re-allocation of risk may exceed an aggregate threshold dollar amount of fraud liability shifted from the merchant to the issuer for a plurality of debit card transactions received from the merchant. When the proposed change exceeds the threshold amount, the issuer or other transaction participant may reject the re-allocation. An issuer may reject the re-allocation by denying the transaction.

Apparatus may include, and methods may involve, one or more non-transitory computer-readable media storing computer-executable instructions. The instructions, when executed by a processor on a computer system, may perform a method. The method may include dynamically allocating a risk associated with accepting a debit card transaction. The debit card transaction may be initiated by a customer as payment for an item offered for sale by a merchant.

The method may include identifying the item as having a SKU associated with a risk allocation flag. The risk allocation flag may indicate that the SKU is associated with a high frequency of post-authorization charges. The frequency may be determined by comparing transactions associated with the SKU to transactions that are not associated with the SKU. A transaction may be associated with the SKU as a result of a purchase including the SKU.

The risk allocation flag may be associated with a transaction based on a performance metric. The performance metric may be determined based on transaction attributes of one or more transactions. The performance metric may be determined based on one or more transactions associated with a transaction participant. For example, the performance metric may be determined based on transactions corresponding to purchases from a merchant. The performance metric may be any suitable performance metric. Table 6 lists illustrative performance metrics.

TABLE 6
Illustrative Performance Metrics

Transaction volume (number)
Transaction volume ($)
Transaction frequency (per item)
Transaction frequency (per sale)
Total sales
Sales per fiscal period
Number of credit card purchases
Number of non-credit card purchases
Number of items purchased
Cost/price per item purchased
Same store sales
Number of transactions authorized per
instrument product type
Number of transaction denied
Interchange revenue per transaction
Interchange revenue per merchant
Interchange revenue per payment instrument
Daily interchange revenue
Number of chargebacks
Number of customer inquiries regarding
transaction participant behavior
Number of fraud investigations associated
with transaction attribute(s)
Number of customer complaints regarding
transaction participant behavior

The method may include receiving a request from a customer to initiate a debit card transaction as payment for an item. In response to determining that the SKU is associated with the risk allocation flag, the method may allocate the risk associated with the debit card transaction among at least two transaction participants.

The at least two transaction participants may correspond to at least two of: a merchant offering the item for sale, a transaction network that processes the debit card transaction, an acquirer bank that processes the debit card transaction on behalf of the merchant and an issuer of the debit card.

Allocating risk may include reducing a monetary value of a payment guarantee issued to a merchant offering the item for sale to the customer. Typically, an issuer may guarantee that, after the issuer provides an authorization for the transaction, a post-authorization charge received after authorizing a transaction will not reduce or otherwise impact an amount of funds transferred from the issuer to the merchant, acquirer and/or other transaction participant. However, the issuer may be unwilling to provide the payment guarantee without mitigating a risk that the post-authorization charge will be incurred. As a result of limits placed on interchange fees, an issuer may be unwilling to provide the payment guarantee without additional remuneration. The additional remuneration may include another transaction participant sharing, with the issuer, a risk that the transaction may be associated with a post-authorization charge.

The method may include determining a portion of the risk to share. The method may include calculating a monetary value of the risk associated with a debit card transaction. The method may include allocating a portion of the risk that is proportional to a difference between: an interchange fee charged to process the debit card transaction as payment for the item and an interchange fee charged to process a credit card transaction as payment for the item. In some scenarios, interchange fees for credit transactions may be regulated to a lesser extent than interchange fees for debit transactions.

A risk of incurring a post-authorization charge may include a risk that the debit card transaction is fraudulent and/or a risk that the debit card transaction is charged back to an issuer of the debit card.

The method may include allocating the risk among the at least two transaction participants when a monetary value of the item exceeds a pre-determined threshold monetary value. When a transaction is associated with an item having a monetary value that exceeds the threshold value, the transaction may be associated with a high risk of incurring a post-authorization charge. The risk may be high relative to transactions associated with lower valued items.

The method may include presenting a risk allocation to a merchant offering the item for sale. In response to a rejection by the merchant of the allocation, the method may include suspending a payment guarantee for the transaction.

Apparatus may include, and methods may involve, an article of manufacture comprising a computer usable medium having code embodied therein. The code when executed by a processor, may apportion a risk of accepting a debit card transaction as payment for a purchase of an item.

The code, when executed by the processor, may receive a scan of a barcode affixed to the item or otherwise identify the item. Based on the identity of the item, the code may determine that the item is associated with a threshold monetary value. In response to detection of the threshold monetary value, the code may transmit an offer of a payment guarantee for the item to a merchant selling the item. A default risk allocation may not include a payment guarantee for a transaction.

The offer may include a full or partial payment guarantee. For example, for payment of a first fee, an issuer may offer a merchant a payment guarantee for 100% of an amount received by the merchant after settlement. In some embodiments, the fee may include an interchange fee. For payment of second fee (less than the first fee) the issuer may offer the merchant a payment guarantee for 50% of an amount received by the merchant after settlement. The code may be configured to calculate any suitable offer.

A payment guarantee may be provided in response to payment of a fee included in the offer. Upon payment of the fee, the transaction may be associated with the payment guarantee. The code, when executed by the processor, may process the transaction without a payment guarantee. When a transaction is processed without the payment guarantee, if a post-authorization cost is incurred, a liability for the post-authorization cost may be borne by any suitable transaction participant. An agreement between transaction participants may assign default liability to one or more transaction participants.

### Location Based Liability Allocation

Apparatus may include, and methods may involve, a computer that is configured to allocate a risk associated with a debit transaction. The risk may be allocated among a plurality of transaction participants. Code, when executed by a processor, may identify a location where the debit transaction is initiated. The debit transaction may be initiated using a payment instrument. The debit transaction may be initiated by providing payment instrument information to a merchant. A transaction record may be generated based on the payment instrument information. The payment instrument information may include one or more transaction attributes.

The code may determine whether the location is associated with a risk of incurring a threshold liability. The threshold liability may correspond to post-authorization charges. The threshold may be any suitable threshold. For example, the threshold may correspond to a threshold number of contested transactions. Each of the contested transactions may have been initiated at the location. The threshold liability may indicate that the location is associated with a higher risk, relative to other locations, of incurring a post-authorization charge for the transaction.

In response to determining that a location is associated with the threshold liability, the code may cause the computer to allocate a risk associated with the debit transaction initiated at the location such that, when a transaction initiated at the location is contested, an issuer of the payment instrument bears less than 100% of the risk. The risk may correspond to a risk that the transaction will incur a post-authorization cost.

A post-authorization cost may include a cost of responding to a contested debit transaction. The debit transaction may be contested by a customer alleging that the transaction was fraudulently initiated.

The code may transmit a tentative allocation of risk to a merchant. The tentative allocation may be transmitted to the merchant before authorizing or requesting authorization for a transaction initiated at the location.

Apparatus may include, and methods may involve, one or more non-transitory computer-readable media storing computer-executable instructions which, when executed by a processor on a computer system, perform a method of dynamically allocating a risk associated with accepting a debit transaction as payment for a purchase. The purchase may be conducted at a merchant location.

The method may include receiving a request to initiate a transaction as payment for the purchase. The method may include identifying a merchant location as being associated with a threshold risk level of incurring post-authorization processing costs associated with the transaction. In response to the identifying the merchant location, the method may include allocating a portion of any potential post-authorization costs among at least two transaction participants that process the debit transaction.

The allocating may include reducing a monetary value of a payment guarantee issued to a merchant that sells goods at the merchant location. The method may include allocating the portion of the post-authorization costs among the transaction participants in a manner that is proportional to a difference between: a first interchange fee charged to process the debit transaction as payment for the purchase and a second interchange fee charged to process a credit transaction as payment for the purchase.

The method may include allocating the post-authorization costs among at least two transaction participants when a value of the purchase exceeds a pre-determined threshold value.

The method may include presenting an allocation of post-authorization costs to a merchant that sells goods at the merchant location. In response to a rejection by the merchant of the allocation, the method may include processing the transaction without a payment guarantee.

Apparatus may include, and methods may involve, an article of manufacture comprising a computer usable medium having computer readable program code embodied therein. The code when executed by a processor apportions a risk of accepting a debit transaction initiated using a payment instrument as payment for a purchase conducted at a location.

The code may determine that a location is associated with a threshold risk level of incurring a post-processing cost for the debit transaction. In response to detection of the threshold risk level, the code may transmit, to a merchant selling the item at the location, an offer of a payment guarantee for the purchase.

The offer may be conditioned on payment of a fee. Upon payment of a fee, the code may register an acceptance of the offer for the payment guarantee.

The code may process the debit transaction without the payment guarantee. For example if the code does not register an acceptance of the offer, the transaction may be processed without the payment guarantee.

### Informational Based Liability Allocation

Apparatus may include, and methods may involve, a computer that shifts risk associated with a transaction initiated by a customer using a payment instrument. The computer may include a non-transitory computer readable medium having code embodied therein. The computer may include a processor configured to execute the computer readable program code.

The code when executed by the processor may identify a transaction initiated using the payment instrument as a debit transaction. The code may be configured to identify any suitable class of transaction. Illustrative classes of transactions include credit transactions, prepaid transactions rewards transaction or any suitable transaction.

In response to identifying the debit transaction, the code may shift a first percentage of the risk associated with the debit transaction from an issuer of the payment instrument to at least one other transaction participant. The first percentage of the risk may be any suitable percentage such as 100%, 75% or 0.2%. In response to the shift of the first percentage of the risk, the code may request that the at least one other transaction participant transmit to the issuer a verification of a relationship between the customer that initiated the debit transaction and the payment instrument.

In response to receiving the verification from the at least one other transaction participant, the code may shift a second percentage of the risk associated with the debit transaction from the at least one other transaction participant to the issuer. The second percentage of the risk may be any suitable percentage such as 100%, 75% or 0.2%. The first percentage may be greater than the second percentage.

The code when executed by the processor may determine the second percentage based on comparing information responsive to the level of verification to information in possession of the issuer. If the information submitted in response to the level of verification matches information in possession of the issuer, the issuer may agree to bear a greater percentage of the risk.

The code when executed by the processor may determine a second percentage of the risk based on information responsive to the requested level of verification. Illustrative information that may be requested by a transaction participant is shown below in table 7. The information may be requested by the transaction participant to reduce a risk of authorizing a transaction that may incur a post-authorization charge. Any suitable combination of the information in table 7 may be requested.

TABLE 7
Illustrative Informational Items

Use designated transaction processing network
Require PIN entry
Display photo ID
Scan barcode on photo ID
Swipe a second payment instrument (for verification purposes only)
Enter billing zip code
Enter billing phone number
Enter billing address street number
Enter birthdate
Enter expiration date associated with payment instrument
Enter portion of card number (i.e., last four digits, entire number)
Respond to text message from transaction participant
Require merchant to transmit transaction “batch” within 24 hours of
authorization

The at least one other transaction participant may correspond to a merchant that accepts the debit transaction as payment for goods sold to customers. The at least one other transaction participant may correspond to an acquirer bank that processes transactions on behalf of the merchant. The at least one other transaction participant may correspond to a transaction network that links the acquirer bank, the merchant and the issuer.

A level of verification may include code that when executed by the processor requests that a merchant obtain from the customer and transmit to the issuer: information printed on the payment instrument and/or a zip code associated with the payment instrument.

The level of verification may include code that when executed by the processor requests that the merchant obtain from the customer and transmit to the issuer: a scan of a barcode printed on a photo identification presented by the customer. The level of verification may include code that when executed by the processor requests that the customer change to a selected transaction network to process the debit transaction. The customer may be required to present another payment instrument to complete the switch.

The level of verification may include code that when executed by the processor, that instructs the merchant to: view a photo identification of the customer that initiated the debit transaction and/or transmit to the issuer a confirmation that information displayed on the photo identification corresponds to information displayed on the payment instrument.

The code when executed by the processor may initiate a transmission to the at least one other transaction participant before a shifting of the first percentage. The transmission may include: the first percentage of risk, the request for the verification, and/or the second percentage of risk. The code when executed by the processor may receive, from the at least one other transaction participant, a waiver of the shift of the second percentage. The waiver may correspond to an agreement by the other transaction participant to bear the first percentage of the risk. The code may process the debit transaction without shifting the second percentage of the risk.

Apparatus may include, and methods may involve, one or more non-transitory computer-readable media storing computer-executable instructions. The computer-executable instructions, when executed by a processor on a computer system, may perform a method of dynamically allocating a risk of accepting a transaction. The transaction may be any suitable transaction such as a credit, debit and/or prepaid transaction. The transaction may be initiated as payment for a purchase. The risk may include a risk that the transaction may incur a post-authorization charge.

The method may include receiving a request from a customer to initiate the transaction as payment for the purchase. The method may include identifying a level of verification for the transaction. In response to the identifying the level of verification, the method may include allocating a percentage of the risk among at least two transaction participants that process the transaction.

In response to allocating the risk, the method may include, receiving information responsive to the level of verification from at least one of the transaction participants. In response to receiving information responsive to the level of verification, the method may include reducing a percentage of the risk allocated to the at least one of the transaction participants.

The at least two transaction participants may include a merchant that accepts the transaction as payment for goods, an acquirer bank that processes the transaction on behalf of the merchant, an issuer of a payment instrument used by the customer to initiate the transaction or a transaction network that links the acquirer bank, the merchant and the issuer.

When the at least one transaction participant is a merchant that that accepts the transaction as payment for goods, the allocating of the risk may include reducing a monetary value of a payment guarantee provided to the merchant by an issuer.

The method may include allocating the risk among the at least two transaction participants in a manner that is proportional to a difference between a first interchange fee charged to process the debit transaction as payment for the purchase and a second interchange fee charged to process a credit transaction as payment for the purchase. The difference may correspond to lost interchange income. The lost interchange income may result in a transaction participate being unable to accept 100% of a risk that the transaction may incur a post-liability charge.

The method may include dynamically allocating a transaction risk based on a value of the purchase. The method may include dynamically determining the level of verification based on a value of the purchase. The method may include determining that the value of the purchase may appear to be unusual for a customer. An unusual value may be a large value. The unusual value may be a small value.

For example, the value of the purchase may be compared to values in historical transaction records. The method may include determining that the value appears to be “excessive” past on the customer's transaction history.

The method may include, after the receiving the transaction and before the allocating risk associated with the transaction, presenting the percentage of the risk to the at least one transaction participant. Presenting the percentage of the risk may provide the transaction participant an opportunity to review the allocation of risk.

For example, after being provided with the allocation of risk, the transaction participant may reject the allocation. In response to a rejection of the allocation, methods may include processing the transaction without a payment guarantee issued to the at least one transaction participant.

Apparatus may include, and methods may involve, an article of manufacture comprising a computer usable medium having computer readable program code embodied therein, the code when executed by a processor may apportion a risk of accepting a transaction initiated by a customer using a payment instrument as payment for a purchase.

The code may determine a threshold risk of incurring a cost for the transaction after the purchase. The cost may be a post-authorization cost. The code, in response to detection of the threshold risk, may transmit to a merchant selling the item, an offer of a payment guarantee for the transaction. The payment guarantee may be offered in exchange for providing an issuer associated with the payment instrument with verification of a relationship between the customer and the payment instrument.

If the merchant does not accept the offer, the code may process the transaction without the payment guarantee. The code may implement the verification of the relationship by prompting the merchant, before authorizing the transaction, to transmit to an issuer of the payment instrument, at least two of: a scan of a barcode printed on a photo identification presented by the customer, a change to a transaction network selected to process the debit transaction, confirmation that information displayed on a photo identification of the customer that initiated the debit transaction matches information displayed on the payment instrument, information printed on the payment instrument or a zip code associated with the payment instrument.

Illustrative embodiments of apparatus and methods in accordance with the principles of the invention will now be described with reference to the accompanying drawings, which form a part hereof. It is to be understood that other embodiments may be utilized and structural, functional and procedural modifications may be made without departing from the scope and spirit of the present invention.

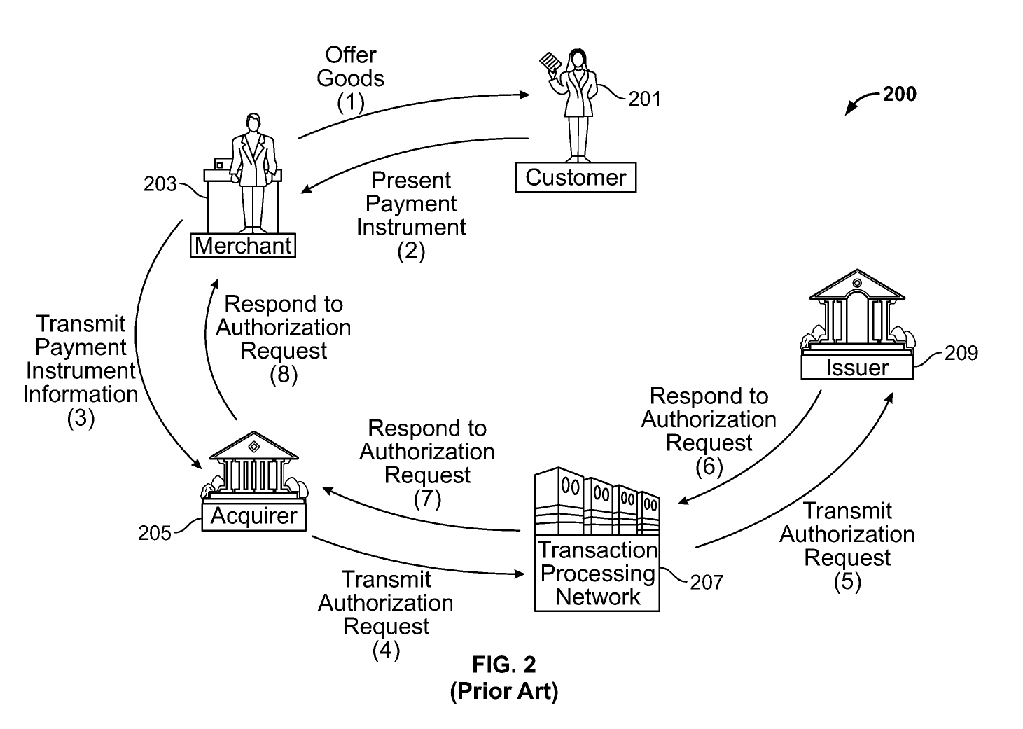

FIG. 2 shows illustrative information flow 200. At step 1, merchant 203 presents goods for sale to customer 201. At step 2, customer 201 presents payment instrument information to merchant 203. Merchant 203 may use the payment information to initiate a transaction and thereby obtain payment for the goods. Customer 201 may present payment instrument information by swiping a payment instrument through a card reader. Customer 201 may present payment instrument information by transmitting the information from a mobile device. Merchant 203 may capture payment information by scanning a display presented on a mobile device of customer 201.

At step 3, merchant 203 may transmit the payment instrument information to acquirer bank 205. At step 4, acquirer bank 205, based on the payment instrument information, formulates an authorization request. The authorization request may be formulated based on a transaction record. The transaction record may include one or more transaction attributes. The transaction record may be generated by merchant 203 or any suitable transaction participant. The authorization request may ask an issuer of the payment instrument to authorize or confirm the transaction initiated by customer 201 to pay merchant 203.

At step 4, acquirer bank 205 transmits the authorization request to transaction processing network 207. Transaction processing network 207 may link a plurality of acquirers and a plurality of issuers. Transaction processing network 207 may route the authorization request to the issuer associated with the payment instrument of customer 201. At step 5, transaction processing network 207 transmits the authorization request to issuer 209. Transaction processing network 207 may identify issuer 209 based on a transaction record.

At step 6, in response to receiving the authorization request, issuer 209 may respond to the request. Typically, the issuer may respond with “APPROVE,” “DENY” or “REFER.” Issuer 209 may only have a few seconds or less to provide a response to an authorization request. Customer 201 may be waiting to collect the goods and leave merchant 203. Issuer 209 may be reluctant to DENY the transaction. Denying a transaction may frustrate customer 201 who may, as a result of a denial, switch to a payment instrument provided by a different issuer. On the other hand, approving a transaction that is later associated with post-authorization costs may negatively affect profitability of issuer 209. At step 6, issuer 209 transmits the authorization response to transaction processing network 207.

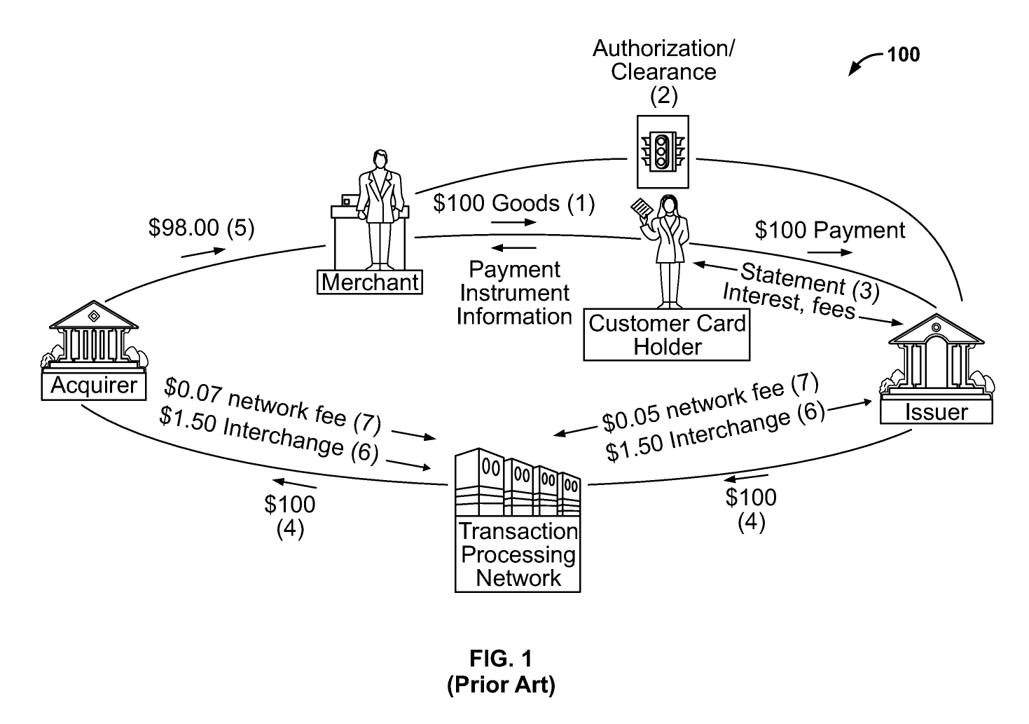

At step 7, transaction processing network 207 routes the authorization response received from issuer 209 to acquirer bank 205. At step 8, acquirer bank 205 informs merchant 203 whether the transaction has been approved or denied. A flow of funds between the transaction participants is depicted in FIG. 1.

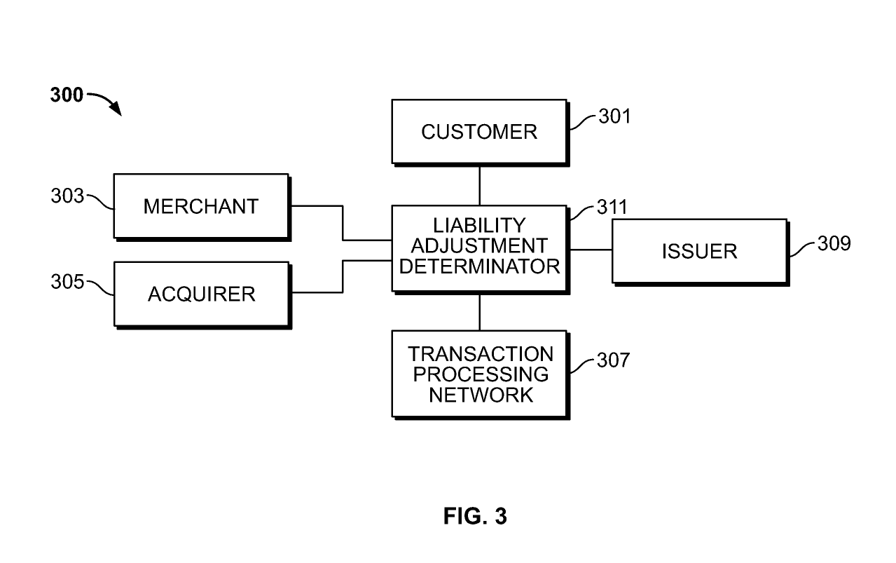

FIG. 3 shows illustrative arrangement 300. Arrangement 300 shows transaction participants in communication with liability adjustment determinator (“LAD”) 311. LAD 311 may allocate responsibility for a liability that arises after the transaction is authorized. The responsibility may include bearing a cost associated with a post-authorization charge. LAD 311 may allocate a risk that a transaction initiated by the customer may incur a post-authorization charge.

For example, LAD 311 may receive a transaction record from merchant 303. LAD 311 may transmit one or more transaction attributes to issuer 309. In some embodiments, LAD 311 may be operated by issuer 309. In some embodiments, LAD 311, may submit a query for information in possession of issuer 309.

Based on information obtained from issuer 309, LAD 311 may assign a risk to the transaction received from merchant 303. For example, issuer may maintain historical transaction records one or more transaction attributes in common with the transaction record received from merchant 303. Based on the risk, LAD 311 may apportion the risk among one or more of customer 301, merchant 303, acquirer 305, transaction processing network 307 and issuer 309. Apportioning the risk may determine which of the transaction participants will bear, at least a portion of, a post-authorization charge associated with the transaction received from merchant 303.

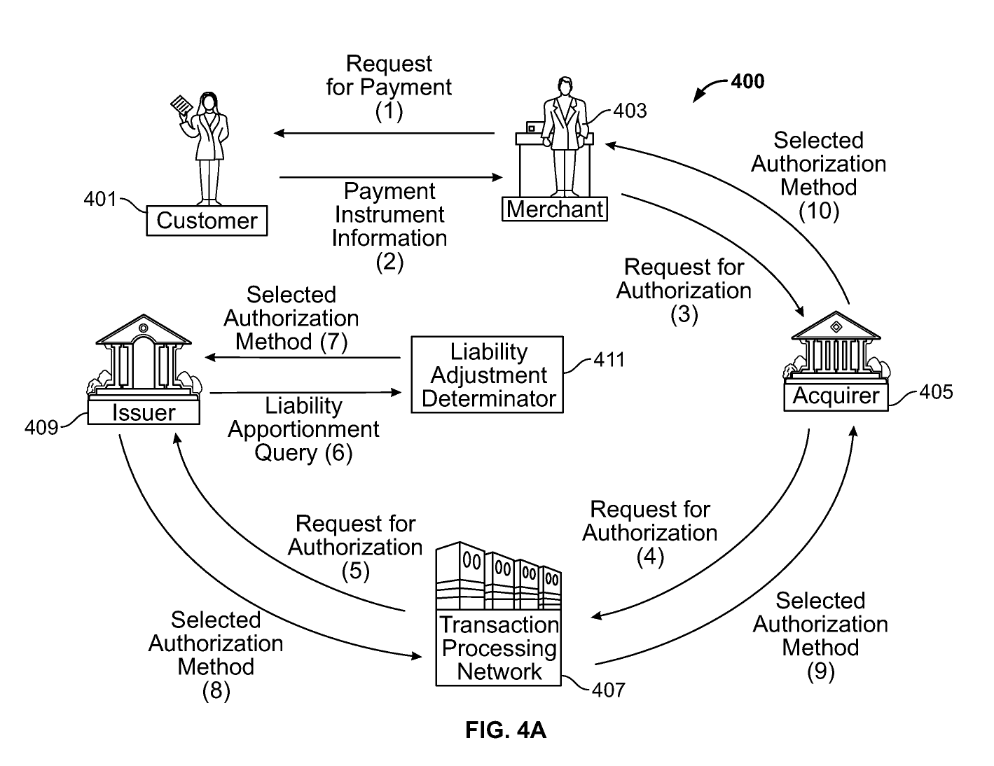

FIG. 4A shows illustrative information flow 400. At step 1, merchant 403 requests that customer 401 remit payment for goods being purchased from merchant 403. At step 2, customer 401 may present payment instrument information to initiate a transaction. Merchant 403 may accepts the transaction as payment for the purchase.

At step 3, merchant 403 requests authorization for the transaction from acquirer 405. At step 4, acquirer 405 transmits an authorization request to transaction processing network 407. At step 5, transaction processing network 407 identifies issuer 409 associated with the payment instrument. At step 5, transaction processing network 407 requests that issuer 409 authorize or deny the transaction.

At step 6, in response to receiving the authorization request from transaction processing network 407, issuer 409 submits the authorization request to liability adjustment determinator (“LAD”) 411. The authorization request may include a transaction record or transaction attributes. Based on the transaction attributes, LAD 411 may evaluate a risk that the transaction may incur a post-authorization charge.

At step 7, LAD 411 responds to issuer 409 with a selected authorization method based on evaluation of the risk. The selected authorization method may require that merchant 403 obtain additional information from customer 401 before issuer 409 authorizes the transaction. The selected authorization method may inform transaction processing network 407, acquirer 405, merchant 403 and/or customer 401 that issuer 409 will not bear 100% of a post-authorization charge associated with the transaction. Issuer 409 may bear none of the risk.

At step 8, the selected authorization method is transmitted from issuer 409 to transaction processing network 407. At step 9, transaction processing network 407 transmits the selected authorization method to acquirer 405. At step 10, acquirer 405 informs merchant 403 of the requirements imposed by the selected authorization method received from issuer 409.

FIG. 4B shows illustrative information flow 402. Flow 402 continues following step 10 in FIG. 4A. At step 11 in flow 402, merchant 403 requests that customer 401 provide information responsive to the selected authorization request. The information, if correct, may mitigate a risk that the transaction incurs a post-authorization charge. The information requested from customer 401 may include information for verifying a relationship between customer 401 and the payment instrument presented by customer 401 to initiate the transaction. Illustrative information that may be requested from customer 401 is shown above in table 7.

At step 12, customer 401 provides information responsive to the selected authorization method to merchant 403. At step 13, merchant 403 routes the responsive information to acquirer 405. At step 14, acquirer 405 routes the responsive information to transaction processing network 407. At step 15, transaction processing network 407 routes the responsive information to issuer 409. At step 16, issuer 409 submits the responsive information to LAD 411. LAD 411 validates the responsive information. The responsive information may be validated by comparing the response of customer 401 to previously stored information associated with the payment instrument.

At step 17, LAD 411 informs issuer 409 of a result of the validating. At step 18, issuer 409 transmits an authorization for the transaction to transaction processing network 407. In some embodiments, if LAD 411 is unable to validate the responsive information, issuer 409 may transmit a denial of the transaction at step 18.

At step 19, transaction processing network 407 routes the authorization to acquirer 405. At step 20, in response to receiving the authorization, merchant 403 releases goods to customer 401. At step 21, acquirer 405 transfers payment for the goods to merchant 403.

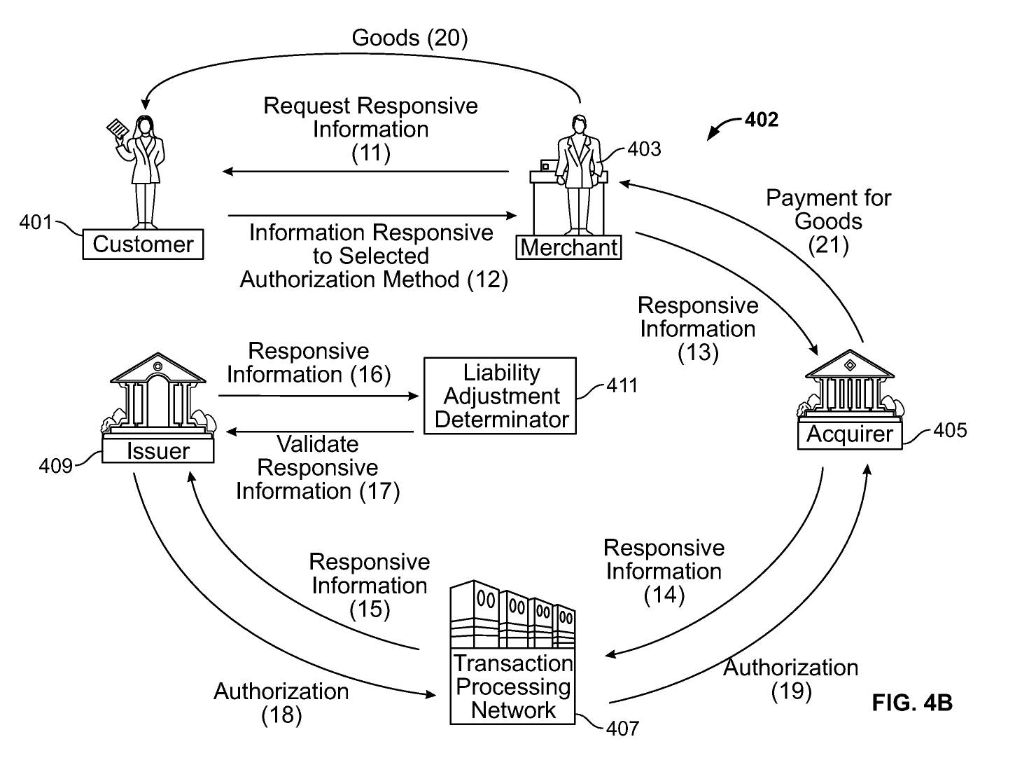

FIG. 5 shows illustrative information flow 500 associated with a post-authorization charge.

At step 1, merchant 503 transfers goods to imposter 502. Merchant 503 may transfer the goods in exchange for a transaction initiated by imposter 502. Imposter 502 may have obtained a payment instrument or payment instrument information of customer 501. The transfer of goods in step 1 is shown in dashed line because imposter 502 may wrongfully obtain possession of the goods.

At step 2, customer 501 may lodge a complaint with issuer 509. Customer 501 may lodge the complaint in response to being billed by issuer 509 for the purchase of the goods transferred to imposter 502. Customer 501 may request that issuer 509 remove a charge of the goods from a billing statement provided to customer 501. Customer 501 may request that issuer 509 refund a payment made to issuer 509 for the goods.

At step 3, in response to receiving the complaint from customer 501, issuer 509 may submit a request for indemnification to transaction processing network 507. The request for indemnification may be based on an apportionment of risk associated with the transaction now contested by customer 501. For example, issuer 509 may have only authorized the contested transaction as a result of other transaction participants accepting a portion of risk that the transaction may incur a post-authorization charge. At step 3, issuer 509 may request indemnification in accordance with the risk allocation determined at a time of authorization.

Each transaction participant may bear a different percentage of the risk. The percentage of risk borne by a transaction participant may determine a monetary amount of indemnification owed to another transaction participant when the risk materializes.

At step 4, transaction processing network 507 may request indemnification from acquirer 505. At step 5, acquirer 505 may request indemnification from merchant 503. Indemnification agreements may implemented by contract or other legally binding methods.

At step 6, merchant 503 indemnifies acquirer 505. At step 7, acquirer 505 indemnifies transaction processing network 507. At step 8, transaction processing network 507 indemnifies issuer 509. At step 9, issuer 509 indemnifies customer 501.

At step 10, issuer 509 transfers a record of the complaint received from customer 501 to liability adjustment determinator (“LAD”) 511. The record of the complaint may include a transaction record of the transaction contested by customer 501. At step 11, in response to a future liability apportionment query, LAD 511 may transmit an updated liability apportionment to issuer 509. The updated liability apportionment may reflect that merchant 503 or goods sold by merchant 503 are at an increased risk of incurring a post-authorization charge. The updated liability apportionment may be based on an actual post-authorization charge incurred as a result of goods sold by merchant 503.

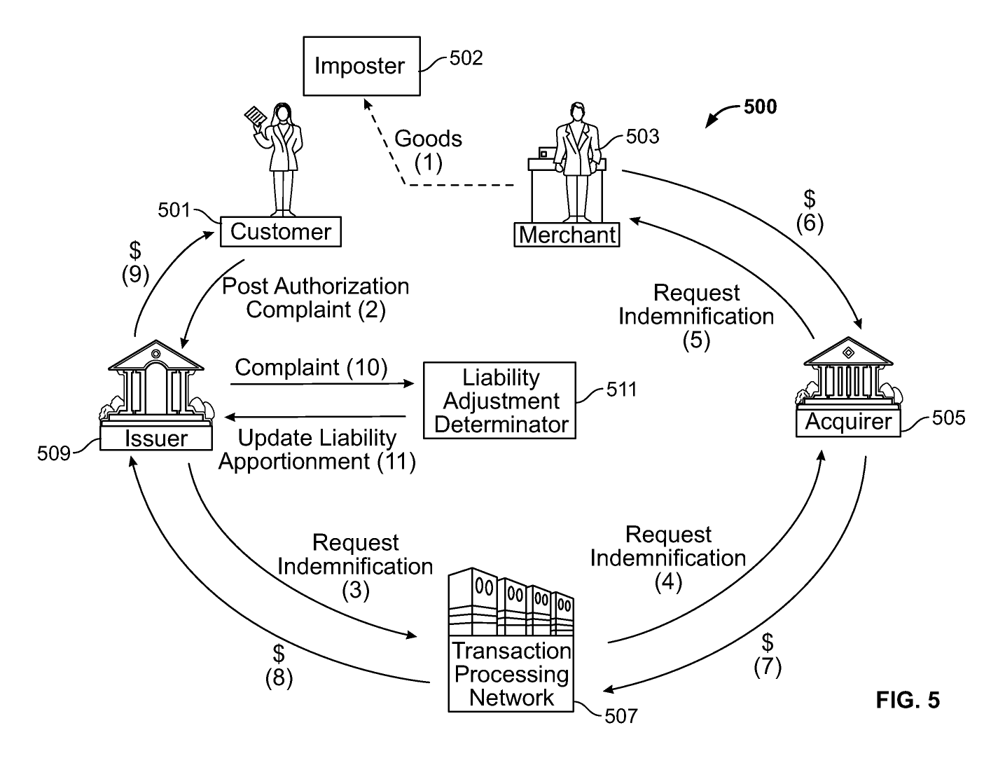

FIG. 6 shows illustrative system 600 for processing and communicating transaction information. Transaction information may include transaction records, authorization responses, information responsive to a selected authorization method, indemnification allocations or any suitable information.

System 600 may include merchant component 602, network component 604 and risk allocation component 606. In some embodiments, risk allocation component may be operated by transaction participant such as an issuer. In general, a system such as 600 may include many merchant components such as 602, many risk allocation components such as 606 and many network components such as 604.

A customer may purchase goods by transferring customer information from a personal data storage device, such as a credit card or smartphone, to point-of-sale (“POS”) terminal 608. POS terminal 608 may read the customer information from the card. The card may store data in a magnetic strip, a bar code, a silicon chip or any other suitable data storage device or format.

The customer information may include issuer information, account information and any other suitable information. Illustrative payment instrument information is shown above in table 4.

POS terminal 608 may transmit transaction information to POS controller 610. The transaction information may include some or all of the customer information and any other suitable information, such as the transaction amount, information regarding the purchased goods and one or more transaction attributes.

POS controller 610 may act as a server for providing user prompts and display layout information to one or more POS terminals such as POS terminal 608. POS controller 610 may receive transaction information from one or more of the POS terminals.

POS controller 610 may transmit the transaction information to host data capture system 612. Host data capture system 612 may store transaction information from POS controller 610. Host data capture system 612 may store accounting data, SKU data, location date and other suitable data that may be included in the transaction information.

The transaction information may include merchant information. The merchant information may include information about the merchant, the merchant's business, the merchant's network membership, the merchant's business behavior and any other suitable information.

Transaction information may include some or all of the information that is necessary to determine a risk allocation for a transaction. The risk allocation may depend on interchange rates, network rates, merchant type, merchant size, transaction processing method, and any other suitable factors.

The transaction information may be stored in any suitable element of merchant component 602, network component 604 and issuer component 606. For example, transaction information may be stored in processor 614. Processor 614 may include algorithms that may be used in conjunction with the transaction information to identify and quantify a risk that a transaction, corresponding to the customer transaction taking place at POS terminal 608, may incur a post-authorization charge.

Host data capture system 612 may create a transaction record based on the transaction information. The transaction record may include some or all of the transaction information. The transaction information may include one or more values that correspond to one or more attributes of the transaction.

POS terminal 608 may have one or more interactive features that the customer may use. The features may provide the customer with information that may help the customer enter information responsive to a selected authorization method transmitted to merchant component 602. For example, POS terminal 608 may display a prompt requesting that the customer enter one or more the informational items shown above in table 7.

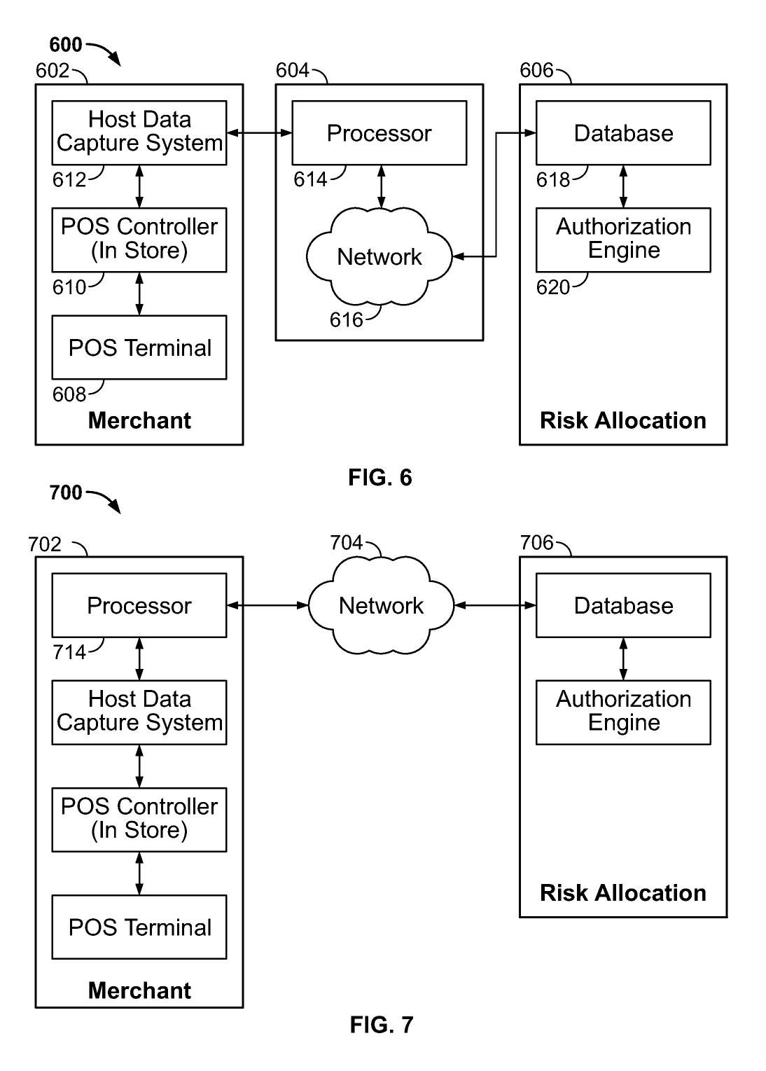

Host data capture system 612 may route the transaction record to processor 614. Processor 614 may include a credit card network “processor,” which is known to those of ordinary skill in the art. The illustrative systems shown in FIGS. 6 and 7 may include one or more other processors that perform tasks that are appropriate for the components thereof.

Processor 614 may route the transaction record, via network 616, to database 618. The routing may be governed by the transaction information. For example, the routing may be governed by a bank issuer number (“BIN”) that is encoded in the customer's credit card. Authorization engine 620 may render a transaction authorization decision based on the transaction information. The authorization decision may include requesting that the customer provide additional information. The additional information may mitigate a risk of the transaction incurring a post-authorization charge.

Authorization engine 620 may transmit authorization information back to POS terminal 608 through network 616, processor 614, host data capture system 612 and POS controller 610. The authorization information may include the authorization decision. The authorization information may include some or all of the transaction information. The transaction information may be used by processor 614 to route the authorization information back to the merchant and the POS terminal where the customer is present.

FIG. 7 shows illustrative system 700 for processing and communicating transaction information. System 700 may include merchant component 702, network component 704 and risk allocation component 706. In general, a system such as 700 may include many merchant components such as 702 and many risk allocation components such as 706. System 700 may have one or more of the features that are described herein in connection with system 600 (shown in FIG. 6).

In system 700, processor 714 may be present in merchant component 702. Corresponding processor 714 is present in network component 604 (shown in FIG. 6).

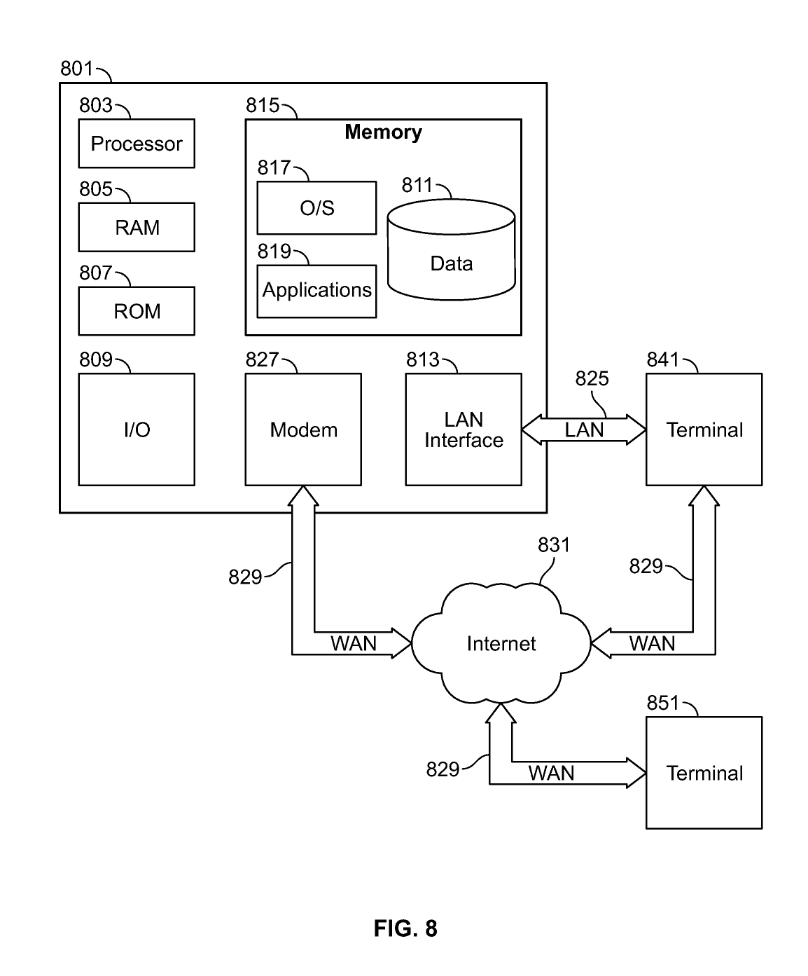

FIG. 8 is a block diagram that illustrates a computing device 801 (alternatively referred to herein as a “server or computer”) that may be used according to an illustrative embodiment of the invention. The computer server 801 may have a processor 803 for controlling overall operation of the server and its associated components, including RAM 805, ROM 807, input/output (“I/O”) module 809, and memory 815.

I/O module 809 may include a microphone, keypad, touch screen and/or stylus through which a user of device 801 may provide input, and may also include one or more of a speaker for providing audio output and a video display device for providing textual, audiovisual and/or graphical output. Software may be stored within memory 815 and/or other storage (not shown) to provide instructions to processor 803 for enabling server 801 to perform various functions. For example, memory 815 may store software used by server 801, such as an operating system 817, application programs 819, and an associated database 811. Alternatively, some or all of computer executable instructions of server 801 may be embodied in hardware or firmware (not shown).

Server 801 may operate in a networked environment supporting connections to one or more remote computers, such as terminals 841 and 851. Terminals 841 and 851 may be personal computers or servers that include many or all of the elements described above relative to server 801. The network connections depicted in FIG. 8 include a local area network (LAN) 825 and a wide area network (WAN) 829, but may also include other networks. When used in a LAN networking environment, computer 801 is connected to LAN 825 through a network interface or adapter 813. When used in a WAN networking environment, server 801 may include a modem 827 or other means for establishing communications over WAN 829, such as Internet 831.

It will be appreciated that the network connections shown are illustrative and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

Additionally, application program 819, which may be used by server 801, may include computer executable instructions for invoking user functionality related to communication, such as email, short message service (SMS), and voice input and speech recognition applications.

Computing device 801 and/or terminals 841 or 851 may also be mobile terminals including various other components, such as a battery, speaker, and antennas (not shown). Terminal 851 and/or terminal 841 may be portable devices such as a laptop, tablet, smartphone or any other suitable device for receiving, storing, transmitting and/or displaying relevant information.

Any information described above in connection with database 811, and any other suitable information, may be stored in memory 815. One or more of applications 819 may include one or more algorithms that may be used to allocate risk, communicate transaction information, determine authorization methods, evaluate information responsive to a selected authorization method and/or any other suitable tasks.

The invention may be operational with numerous other general purpose or special purpose computing system environments or configurations. Examples of well-known computing systems, environments, and/or configurations that may be suitable for use with the invention include, but are not limited to, personal computers, server computers, hand-held or laptop devices, tablets, mobile phones and/or other personal digital assistants (“PDAs”), multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

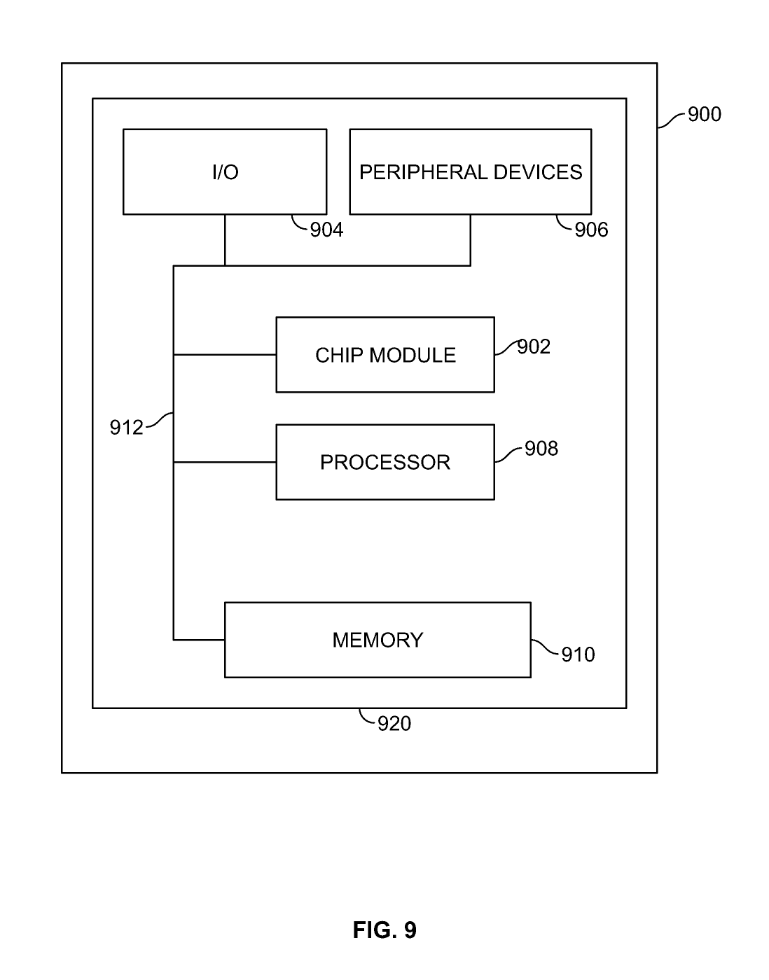

FIG. 9 shows illustrative apparatus 900. Apparatus 900 may be a computing machine. Apparatus 900 may include one or more features of the apparatus shown in FIG. 8. Apparatus 900 may include chip module 902, which may include one or more integrated circuits, and which may include logic configured to perform any other suitable logical operations.

Apparatus 900 may include one or more of the following components: I/O circuitry 904, which may include a transmitter device and a receiver device and may interface with fiber optic cable, coaxial cable, telephone lines, wireless devices, PHY layer hardware, a keypad/display control device or any other suitable encoded media or devices; peripheral devices 906, which may include counter timers, real-time timers, power-on reset generators or any other suitable peripheral devices; logical processing device 908, which may compute data structural information, structural parameters of the data, quantify indices; and machine-readable memory 910.

Machine-readable memory 910 may be configured to store in machine-readable data structures: authorization method, record of risk allocation for a transaction and any other suitable information or data structures.

Components 902, 904, 906, 908 and 910 may be coupled together by a system bus or other interconnections 912 and may be present on one or more circuit boards such as 920. In some embodiments, the components may be integrated into a single chip. The chip may be silicon-based.

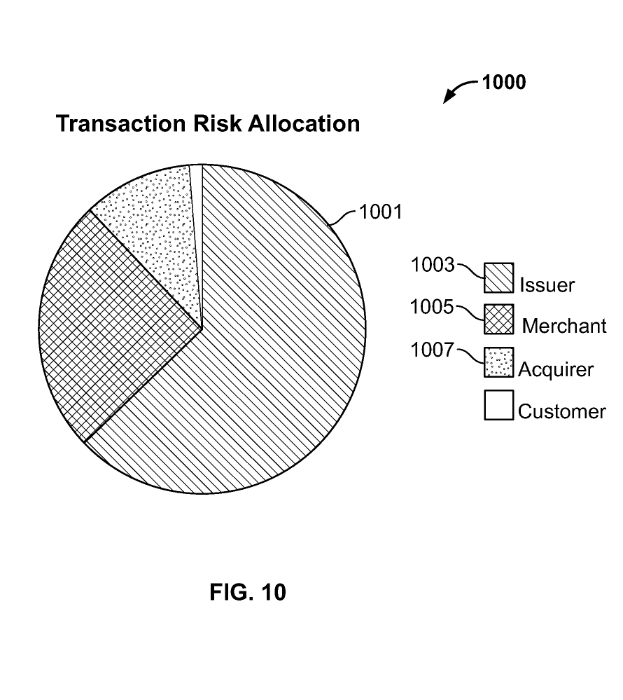

FIG. 10 shows information 1000. Information 1000 shows an illustrative allocation of risk 1001 among issuer 1003, merchant 1005, acquirer 1007 and customer 1009. The risk allocation may be determined by a “system.” The “system” may include one or more of the features of the apparatus, arrangements information or processes shown in FIGS. 1-9 and/or any other suitable device or approach. The “system” may be provided by an entity. The entity may be an individual, an organization, a transaction participant or any other suitable provider.

As will be appreciated by one of skill in the art, the invention described herein may be embodied in whole or in part as a method, a data processing system, or a computer program product. Accordingly, the invention may take the form of an entirely hardware embodiment, an entirely software embodiment or an embodiment combining software, hardware and any other suitable approach or apparatus.

Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space).

One of ordinary skill in the art will appreciate that the steps shown and described herein may be performed in other than the recited order and that one or more steps illustrated may be optional. The methods of the above-referenced embodiments may involve the use of any combination of methods, portions of methods, partially executed methods, elements, one or more steps, computer-executable instructions, or computer-readable data structures disclosed herein. In this regard, other embodiments are disclosed herein as well that can be partially or wholly implemented on a computer-readable medium, for example, by storing computer-executable instructions or modules or by utilizing computer-readable data structures.

Thus, systems and methods for allocating transaction liability have been provided. Persons skilled in the art will appreciate that the present invention can be practiced by other than the described embodiments, which are presented for purposes of illustration rather than of limitation. The present invention is limited only by the claims that follow.

What is claimed is:

1. A computer that is configured to allocate a risk associated with a debit transaction among a plurality of transaction participants, the computer comprising:
a non-transitory computer readable medium having computer readable program code embodied therein; and
a processor configured to execute the computer readable program code;
the computer readable program code comprising:
computer readable code for causing the computer to identify a location where the debit transaction is initiated using a payment instrument;
computer readable code for causing the computer to determine whether the location is associated with a threshold liability associated with a threshold number of contested transactions; and
computer readable code for causing the computer, in response to determining that the location is associated with the threshold liability, allocate the risk of the debit transaction initiated at the location such that, when the debit transaction initiated at the location is contested, an issuer of the payment instrument bears less than 100% of a cost of responding to the contested debit transaction.

2. The computer of claim 1, further comprising computer readable code for causing the computer to allocate at least a portion of the risk to a merchant that accepts the debit transaction as payment for goods sold to a customer at the location.

3. The computer of claim 2, further comprising computer readable code for the causing the computer to allocate at least a portion of the risk to an acquirer bank that enables the merchant to process the debit transaction.

4. The computer of claim 1, further comprising computer readable code for the causing the computer to:
allocate a first portion of the cost to a merchant that accepts the debit transaction as payment for goods sold to a customer at the location; and
allocate a second portion of the of the cost to an acquirer bank that enables the merchant to process the debit transaction.

5. The computer of claim 1, further comprising computer readable code for the causing the computer to:
allocate a first portion of the cost to a merchant that accepts the debit transaction as payment for goods sold to a customer at the location; and
allocate a second portion of the cost to the issuer of the payment instrument.

6. The computer of claim 1, further comprising computer readable code for the causing the computer to:
allocate a first portion of the cost to a merchant that accepts the debit transaction as payment for goods sold to a customer at the location;
allocate a second portion of the cost to the issuer of the payment instrument; and
allocate a third portion of the cost to a transaction network that processes the debit transaction.

7. The computer of claim 1 further comprising computer readable code for causing the computer to transmit the allocation of the risk generated by the computer to a merchant that accepts the debit transaction as payment for goods sold to a customer at the location before completing the debit transaction initiated at the location.

8. The computer of claim 7 further comprising computer readable code for causing the computer to receive, from the merchant, a proposed change to the allocation of the risk generated by the computer.

9. The computer of claim 8 further comprising computer readable code for causing the computer to deny the debit transaction initiated at the location when, for a plurality of debit transactions initiated at the location, the proposed change to the allocation exceeds an aggregate threshold dollar amount of risk shifted from the merchant to the issuer of the payment instrument.

10. The computer of claim 1, wherein the risk comprises a cost to investigate a claim submitted to the issuer of the payment instrument alleging that the debit transaction initiated at the location was fraudulent.

11. One or more non-transitory computer-readable media storing computer-executable instructions which, when executed by a processor on a computer system, perform a method of dynamically allocating a risk of accepting a debit transaction as payment for a purchase at a merchant location, the method comprising:
receiving a request to initiate the debit transaction as payment for the purchase;
identifying the merchant location as being associated with a threshold risk of incurring, after the purchase, a post-authorization charge for the debit transaction;
in response to the identifying, allocating a portion of the post-authorization charge among at least two transaction participants that process the debit transaction.

12. The computer-readable media of claim 11, wherein the at least two transaction participants selected from:
a merchant that sells goods at the merchant location;
a transaction network that processes the debit transaction;
an acquirer of the merchant; and
an issuer of a payment instrument used by the customer to initiate the debit transaction.

13. The computer-readable media of claim 11 wherein, in the method, the allocating comprises reducing a monetary value of a payment guarantee issued to a merchant that sells goods at the merchant location.

14. The computer-readable media of claim 11, the method further comprising allocating the portion of the post-authorization charge among the transaction participants in a manner that is proportional to a difference between:
a first interchange fee charged to process the debit transaction as payment for the purchase; and
a second interchange fee charged to process a credit transaction as payment for the purchase.

15. The computer-readable media of claim 11, wherein in the method, the post-authorization charge comprises:
a cost of responding to an allegation that the debit transaction was fraudulently initiated; and
a cost of a chargeback of the debit transaction.

16. The computer-readable media of claim 11, the method further comprising allocating the post-authorization charge among the at least two transaction participants when a value of the purchase exceeds a pre-determined threshold value.

17. The computer-readable media of claim 11, the method further comprising:
presenting the allocation of the post-authorization charge to a merchant that sells goods at the merchant location; and
in response to a rejection by the merchant of the allocation, suspending a payment guarantee issued to the merchant for the debit transaction.

18. An article of manufacture comprising a computer usable medium having computer readable program code embodied therein, the code when executed by a processor apportions a risk of accepting a debit transaction initiated using a payment instrument as payment for a purchase at a location, the computer readable program code in said article of manufacture comprising:
computer readable code for determining that the location is associated with a threshold risk of incurring a post-processing cost for the debit transaction; and
computer readable code for, in response to detection of the threshold risk, transmitting to a merchant selling the item at the location, an offer of a payment guarantee for the transaction.

19. The article of claim 18 further comprising computer readable code for accepting the offer of the payment guarantee upon payment of a fee.

20. The article of claim 19 further comprising computer readable code for processing the debit transaction without the payment guarantee.
